(19) United States
(12) Patent Application Publication
(10) Pub. No.: US 2006/0095225 A1
(43) Pub. Date: May 4, 2006

(54) Method and computer program for pattern analysis and reporting of chronic disease state management data

(76) Inventors: Kirk Harmon, San Ramon, CA (US); Michael Bell, Morgan Hill, CA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/265,977

(22) Filed: Nov. 2, 2005

Related U.S. Application Data
(60) Provisional application No. 60/624,804, filed on Nov. 2, 2004.

(51) Int. Cl. G01D 1/00

(52) U.S. Cl. 702/127

(57) ABSTRACT

A computer-implemented method of visualizing time-dependent data is disclosed. The method comprises loading at least a first set of time-dependent data into a computer. The method also comprises color coding the at least first set of time-dependent data with the computer. Further, the method comprises generating an output from the computer such that clinically significant excursions in the at least first set of time-dependent data are visually identified. The at least first set of time-dependent data may be sorted according to a plurality of configurable time periods. The color coding step may include selecting at least one of a color and a brightness as a function of numerical values of the time-dependent data. A computer-implemented method of visualizing time-dependent data of at least two time-dependent sets of data is also disclosed. The method comprises loading at least a first and second set of time-dependent data into the computer. The method also comprises calculating a percent change between the first and second set of time-dependent data. Further, the method comprises color coding the percent change between the first and second set of time-dependent data and generating an output from the computer such that clinically significant excursions in the percent change between the at least first and second set of time-dependent data are visually identified. The at least first and second set of time-dependent data is sorted according to a plurality of configurable time periods, and the color coding step includes selecting at least one of a color and a brightness as a function of the percent change.

### REFERENCE TO RELATED APPLICATIONS

This application is a nonprovisional application which claims priority to U.S. Provisional application No. 60/624,804, entitled METHOD AND COMPUTER PROGRAM FOR PATTERN ANALYSIS AND REPORTING CHRONIC DISEASE STATE MANAGEMENT DATA, filed on Nov. 2, 2004, which is herein incorporated by reference in its entirety.

### BACKGROUND

The invention generally relates to a system for managing health care and, in particular, to a system and method for monitoring health parameters of individual patients with a chronic disease.

Managing a chronic disease requires continued monitoring and controlling of health parameters, such as blood glucose levels for patients with diabetes, or cholesterol levels for patients with cardiovascular disease. Because of the chronic nature of such diseases, health parameters must be measured on a continuous basis by the patients themselves outside a clinical setting.

Periodic monitoring of the patient's health status is also required of an attending physician within a clinical setting. For patients with diabetes, this involves analyzing a large number of blood glucose values from various times throughout the day and over numerous days. Such large sets of numeric data prove difficult for physicians to analyze efficiently and effectively in a time-limited encounter (e.g. office visit) in a clinic. Thus, trends in either low or high blood glucose values that can indicate the need for medical intervention can be overlooked.

Several methods have been developed to help visually analyze large sets of numeric data. These include converting numeric data into a graphical format, and fragmenting the data into clusters. However, these methods require the user to define and select variables prior to data analysis. Such efforts would be cumbersome when analyzing blood glucose data during a time-limited encounter in a clinic.

Thus, still needed in the field is a system and method for rapid visualization of a large set of numeric data. Optionally, this system would facilitate the storage and analysis of critical patient information obtained on a routine basis and analyzed in an automated fashion during a time-limited encounter in a clinic. Optionally, such analyses could include historical trending of blood glucose results such that data presented to a physician at two separate encounters by a single patient can be compared to determine how well the disease is being managed by the patient. In addition, a system and method is still needed to allow physicians to analyze results of multiple patients using most brands of metering systems. Thus, the burden on physicians to evaluate the large sets of numeric data is significantly reduced while the benefits to the patients are greatly enhanced.

The techniques herein below extend to those embodiments which fall within the scope of the appended claims, regardless of whether they accomplish one or more of the above-mentioned needs.

### SUMMARY

What is provided is a computer-implemented method of visualizing time-dependent data. The method comprises loading at least a first set of time-dependent data into a computer. The method also comprises color coding the at least first set of time-dependent data with the computer. Further, the method comprises generating an output from the computer such that clinically significant excursions in the at least first set of time-dependent data are visually identified. The at least first set of time-dependent data may be sorted according to a plurality of configurable time periods. The color coding step may include selecting at least one of a color and a brightness as a function of numerical values of the time-dependent data.

What is also provided is a system for visualizing time-dependent data. The system comprises a means for storing and processing data. The means for processing data is configured to: obtain at least a first set of time-dependent data from the means for storing data. The means for processing data is also configured to color code the at least first set of time-dependent data. Further, the means for processing is configured to generate an output from the computer such that clinically significant excursions in the at least first set of time-dependent data are visually identified. The at least first set of time-dependent data may be sorted according to a plurality of configurable time periods, and the color coding step may include selecting at least one of a color and a brightness as a function of a quantitative value.

Further, what is provided is a system for visualizing time-dependent data. The system comprises a metering device, data processing device, and a memory coupled to the data processing device. A computer program runs on the data processing device, the computer program is configured to obtain at least a first set of time-dependent data from the means for storing data, color code the at least first set of time-dependent data, and generate an output from the computer such that clinically significant excursions in the at least first set of time-dependent data are visually identified. The at least first set of time-dependent data may be sorted according to a plurality of configurable time periods. The color coding step may include selecting at least one of a color and a brightness as a function of a normalized value.

Further still, what is provided is a computer-implemented method of visualizing time-dependent data. The method comprises loading at least a first and second set of time-dependent data into the computer. The method also comprises calculating a percent change between the first and second set of time-dependent data. Further, the method comprises color coding the percent change between the first and second set of time-dependent data. Further still, the method comprises generating an output from the computer such that clinically significant excursions in the percent change between the at least first and second set of time-dependent data are visually identified. The at least first and second set of time-dependent data may be sorted according to a plurality of configurable time periods, and the color coding step may include selecting at least one of a color and a brightness as a function of the percent change.

Yet further still, what is provided is a system for visualizing time-dependent data. The system comprises a means for storing and processing data, a means for obtaining at least a first and second set of time-dependent data from the means for storing data, and a means for calculating the percent change between the first and second set of time-dependent data. The system also comprises a means for color coding the percent change between the first and second set of time-dependent data and a means for generating an output from the computer such that clinically significant excursions in the percent change between the at least first and second set of time-dependent data are visually identified. The at least first set of time-dependent data may be sorted according to a plurality of configurable time periods, and the means for color coding may select at least one of a color and a brightness as a function of the percent change.

Alternative exemplary embodiments relate to other features and combination of features and combination of features as may be generally recited in the claims.

### BRIEF DESCRIPTION OF THE DRAWINGS

A better understanding of the features and advantages of the present invention will be obtained by reference to the following detailed description that sets forth illustrative embodiments by way of example only, in which the principles of the invention are utilized, and the accompanying drawings, of which:

FIG. 1 is a block diagram illustrating the hardware components for the method and system according to an exemplary embodiment;

FIG. 2 is a flowchart illustrating a sequence of steps in a method according to an exemplary embodiment;

FIG. 3 illustrates a start-up window in a method and system according to an exemplary embodiment;

FIG. 4 illustrates a window for color coding control parameters in a method and system according to an exemplary embodiment;

FIG. 5 is a template for a color-based report for data interpretation generated by a computer program according to an exemplary embodiment;

FIG. 6 is a flowchart illustrating a sequence of steps in a process for color coding blood glucose numeric results by a computer program according to an exemplary embodiment;

FIG. 7 is portion of a single encounter color-based report for data interpretation generated by a computer program according to an exemplary embodiment;

FIG. 8 is a flowchart illustrating a sequence of steps in a process used to calculate a normalized percentage for each numeric result from a single encounter by a computer program according to an exemplary embodiment;

FIG. 9 is a portion of a normalized single encounter color-based report for data interpretation generated by a computer program according to an exemplary embodiment;

FIG. 10 is a flowchart illustrating a sequence of steps in a process 1000 used to compare the numeric results from a previous encounter with the numeric results from a current encounter by a computer program according to an exemplary embodiment;

FIG. 11 is a portion of an encounter comparison report for data interpretation generated by a computer program according to an exemplary embodiment; and

FIG. 12 is an example demonstrating the results of a single encounter using data from a patient's metering system to generate a color-based report for data interpretation by a computer program according to an exemplary embodiment.

### DETAILED DESCRIPTION

Utilizing color to represent numeric results can provide a useful alternative to other types of data analysis methods. Color coding is a process that codes numeric results within a data set into a grid or data space then fills each grid cell with the appropriate color such that the fill color of the cell represents the numeric value of the cell, an example of which is implemented in OneTouch™ Diabetes Management Software Pro from LifeScan, Inc. Systems and Methods for providing color coded data for a disease management system are described herein.

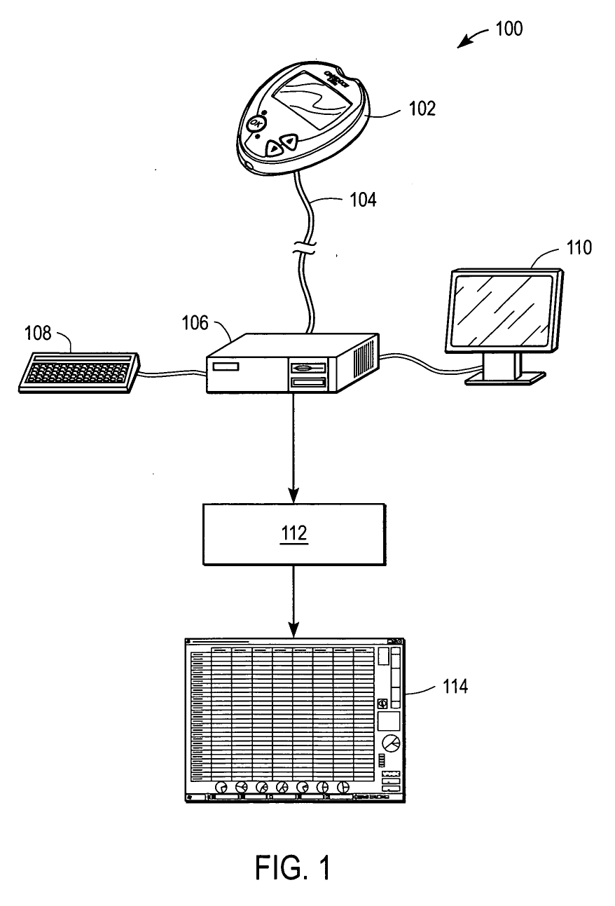

FIG. 1 illustrates a system 100 that implements a computer program 112 according to an exemplary embodiment. System 100 includes a data source 102, a communications link 104, and a processing station 106 preferably connected to one or more input devices 108, a visual display 110. Processing station 106 includes a storage means for storing and saving information by System 100, and a data processing means with linked algorithms used to process data from data source 102. Examples of data source 102 can include, but are not limited to, a blood glucose metering system, continuous metering systems for detecting glucose in blood or interstitial fluid as described International Patent Application No. PCT/GB01/05644 published as WO02/50534 on Oct. 8, 2003, which is fully incorporated herein by reference. A metering system for detecting other analytes or indicators (e.g. cholesterol, HbA1c, or glucose) in any body fluid (e.g. blood, urine, interstitial fluid, etc) could also be used.

Generally, data source 102 may comprise any type of data input device, including but not limited to metering and measuring devices designed to test for physical characteristics. Data source 102 may further include input devices, (e.g., buttons, keys, touch screens, on screen menus, user interfaces, etc.) to input lifestyle information or other information such as, but not limited to quality and duration of exercise, weight data, type and quantity of diabetes medication, and general nutritional information. Data source 102 can be connected to a processing station 106 via a communications link 104 that may comprise any known or later developed wired or wireless communication link. Examples of communications link 104 include, but are not limited to, a direct serial or USB cable, a TCP/IP or Ethernet based network connection or a wireless connection using protocols such as 802.11 or IrDA (via InfraRed), or Bluetooth. In an exemplary embodiment, data source 102 is connected directly to processing station 106 via an appropriate cable.

Processing station 106 includes a device to save and store information (e.g., a memory, a disk drive, or other removable storage device, a database, etc.) and a device to process data (e.g., a central processing unit or CPU) from data sources 102 using algorithms within and desired software, such as within program 112. Examples of processing station 106 can include, but are not limited to, a personal computer, a Personal Digital Assistant (PDA), a mobile telephone, or a networked computer. Examples of input devices 108 may include, but are not limited to, a keyboard, a mouse, a joystick, a stylet, as well as others which are useable with central processing unit devices. Examples of visual display 110 may include, but are not limited to, a display monitor for a personal or networked computer, or a Liquid Crystal Display (LCD) screen for a personal digital assistant (PDA). Alternatively, one or more lights, such as LED's, may be used on the device to communicate information by glowing and/or blinking. The processing station 106 can provide access to algorithms for data sorting, and color coding as well as expert system tools to help users control processes of computer program 112. Once computer program 112 initiates, data from data source 102 is incorporated into computer program 112 and processing station 106 manipulates data to generate a color-based report 114 for data interpretation (to be described below).

Processing station 106 further includes computer program 112 for color-based data analysis according to an exemplary embodiment. Computer program 112 controls the processing station 106 to perform many steps of the exemplary method. Computer program 112 utilizes standard menu approaches to permit the user access to all of its functions. Computer program 112 may be written in any computer language as a matter of design choice and may be stored on any computer-readable memory device such as a hard drive coupled with a computer processing unit. In an exemplary embodiment, computer program 112 is written in a general purpose computer language such as, for example, Visual Basic, C++, or Java.

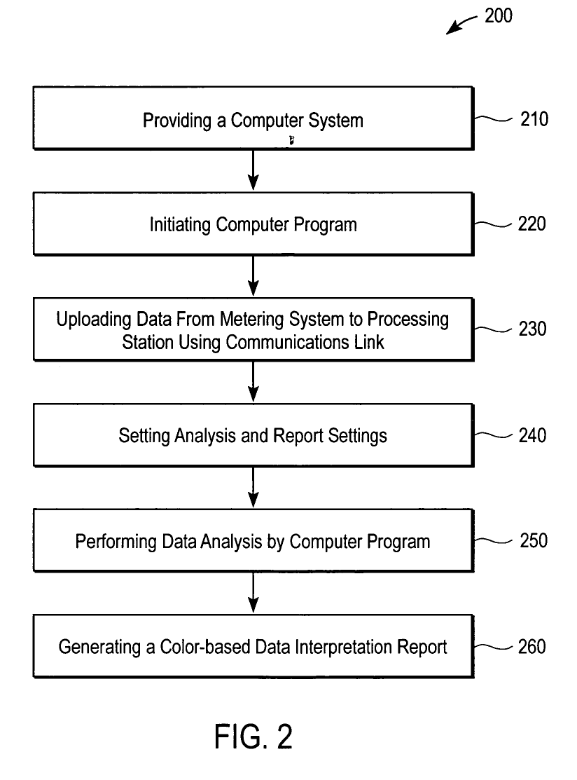

FIG. 2 is a flowchart illustrating a sequence of steps in a method 200 for computer program 112 to analyze data and generate a color-based report 114 for data interpretation according to an exemplary embodiment.

Method 200 includes first providing a system 100 as described above with respect to FIG. 1 and as set forth in step 210. Further, other systems which are capable of carrying out the steps of method 200 are also within the scope of the invention. Like elements are numbered similarly. The provided system 100 or other system includes devices and functionality for inputting, processing, and reporting blood glucose, or other analyte, numeric results, as will be described below. In accordance with an exemplary embodiment, during this process, individual blood glucose numeric results from a patient's metering system are uploaded into computer program 112. Computer program 112 then analyzes the numeric results based on pre-set analysis and report settings to generate a color-based report 114 for data interpretation. Although reference to blood glucose metering is described here, the systems, methods, and devices may be applied to the determination of other analyte concentrations, especially those which may be present in a physiological fluid.

Next, the user (e.g. physician, nurse, or diabetes educator) initiates computer program 112 as set forth in step 220. To initiate computer program 112, the user may access a processing station 106 of system 100 and open computer program 112 using the appropriate input device 108, such as, for example a mouse, a keyboard, a joystick, or a stylet. Other methods of initiating computer program 112 may also be used. Such as, but not limited to providing a remote command to processing station 106 over a communication network, having a computer program 112 automatically start upon powering up of processing station 106, etc.

The user then may upload the current encounter's numeric results from the patient's metering system to processing station 106 using the appropriate communications link 104, as set forth in step 230. In an exemplary embodiment, the metering system is connected directly to processing station 106 via an appropriate cable, IR, RF, or any other way of providing a data communication connection. Uploaded numeric results may be integrated within computer program 112 or any other operation on the numeric results. A patient may be tracked by using the metering system serial number, as is known to those skilled in the art. Other methods of tracking a particular patient may also be used including, but not limited to by name, social security number, or other identification techniques. Incoming data may be from either a returning patient or a new patient. Data from a returning patient may be incorporated into the pre-existing patient file. When data from a new patient is uploaded, the user is prompted by a pop-up window (not shown) to add demographic information for the new patient. Incoming data from the current patient encounter can be either saved for analysis at a later date, or saved and analyzed during the current patient encounter. Other methods may be used to track patients and to maintain demographic information about the patient database over a communication network.

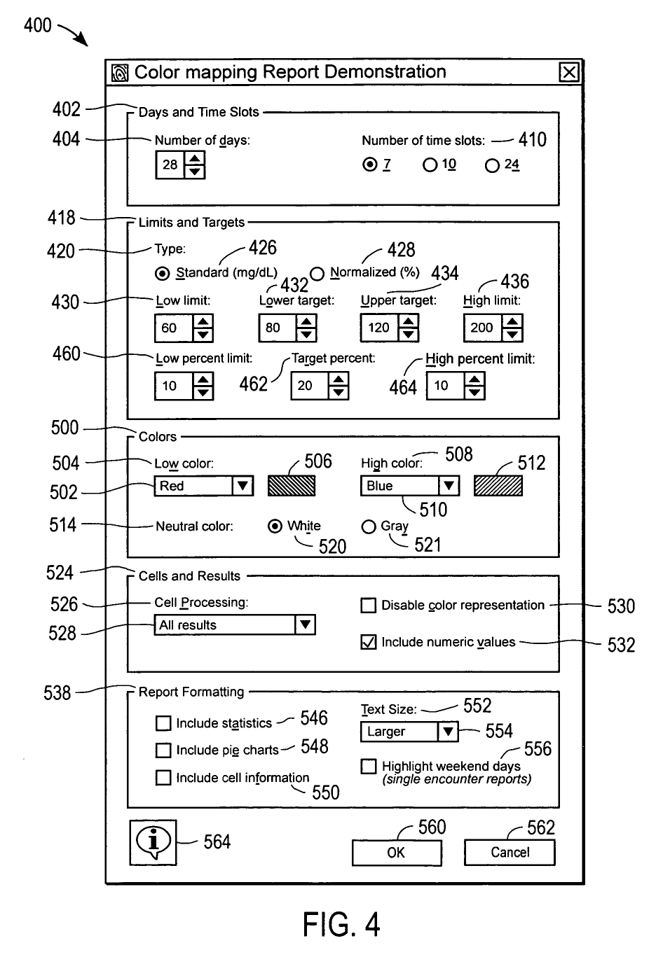

Next, the user may set the analysis and report settings as set forth in step 240. Though listed in sequence in method 200, the selection of analysis and report settings (to be described below; see FIG. 4) can be set or programmed to occur at any of a variety of times and may be changed interactively. Numeric results may be analyzed as a current single encounter or compared to a previous encounter if the data is from a returning patient's metering system. This can be useful to compare a patient's progress between two encounters, two weeks, two months, or over n days. In this step, the user can also optionally add additional patient information, for example, medication regime, dietary regime, exercise regime, and/or other health parameter results. The user may also optionally upload this information from the patient's metering system. Further, other information may be added, either automatically, such as from a patient database or manually, such as comments by or about the patient, etc.

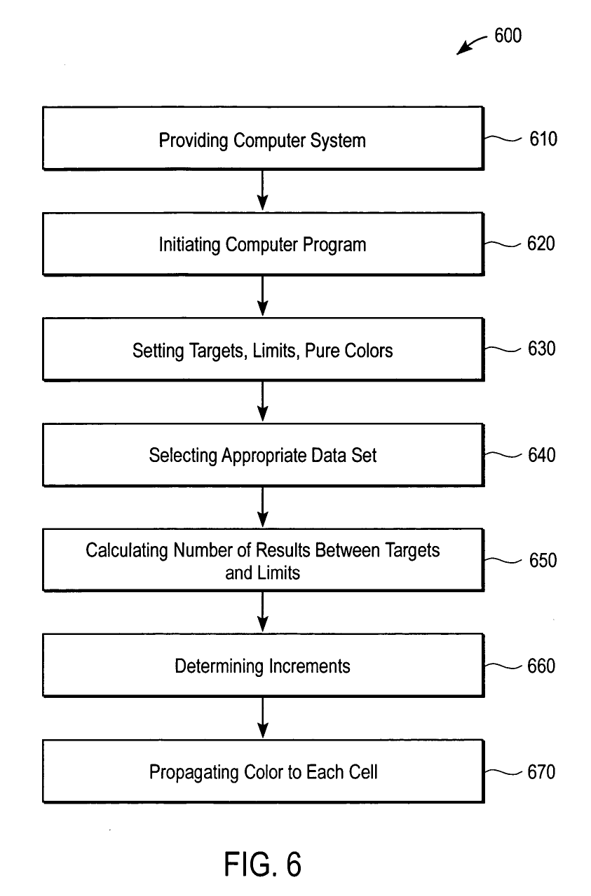

The user then directs the computer program 112 to perform data analysis (to be described below; see FIGS. 6-11) as set forth in step 250. In this step, computer program 112 can analyze the numeric results from a single encounter or can compare the numeric results from two encounters with the same patient. This process may be automatically triggered upon the completion of certain events, such as when meter 102 is connected to system 106, or manually, when the user provides a command to processing station 106 or to meter 102.

Finally, the computer program 112 generates a color-based report 114 for data interpretation, as set forth in step 260. To generate color-based report 114 for data interpretation, the user can select a format in which color-based report 114 for data interpretation is presented. Formats can include, but are not limited to, printing a copy to the user/patient, emailing a copy to the user/patient, or faxing a copy to the user/patient. Further, the color-based report may be provided to the user/patient on display 110. The user can also select to receive color-based report 114 for data interpretation with additional patient information incorporated into the final patient results. Such a color-based report 114 for data interpretation gives the user a rapid cognitive grasp of the recent blood glucose data from the patient.

The software components as described in method 200 can be a stand alone computer program 112 or one or more computer modules integrated into an existing computer program such as, for example, the OneTouch™ Diabetes Management Software Pro from LifeScan, Inc. If computer program 112 is stand alone, computer program 112 can be independent of metering system brand, such that data from any metering system brand can be uploaded to computer program 112 without compatibility error. In either configuration, computer program 112 allows processing station 106 to accept data from data source 102, to store the incoming data as a patient file, to process the accepted and stored data using a main computer program 112 and a plurality of associated plug-ins in conjunction with a set of user-defined control options, and to generate a color-based report 114 for data interpretation that color codes the numeric results from a metering system or calculated percentages based on the numeric results from a metering system. In alternative embodiments, other calculated values may be color-coded according to the needs of the user/patient.

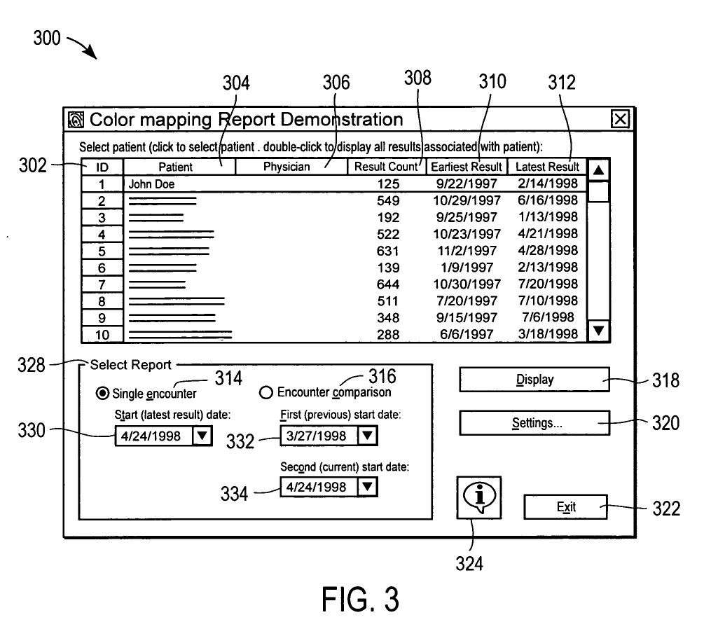

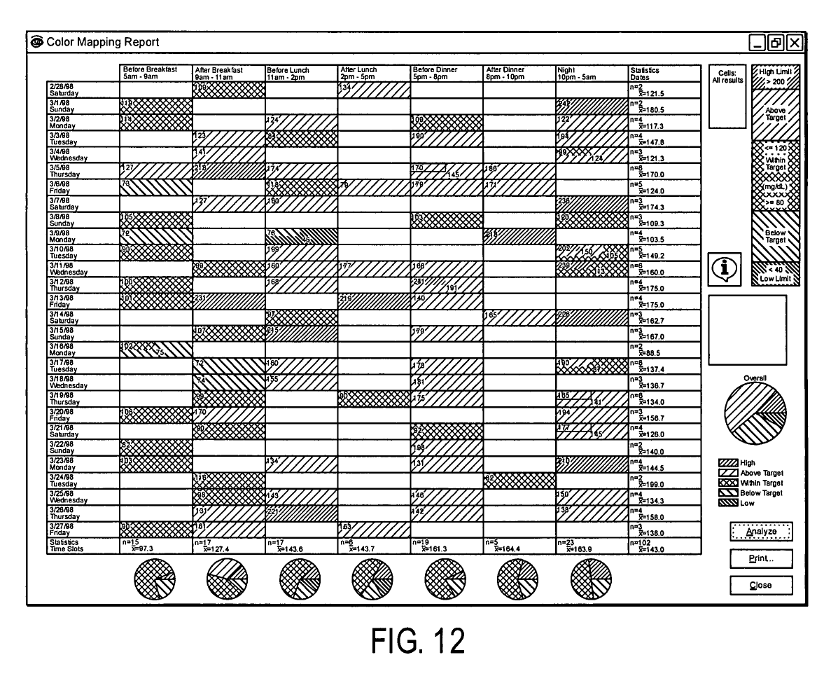

FIG. 3 illustrates an exemplary start-up window 300 of an exemplary embodiment of computer program 112. Start-up window 300 includes columns for patient ID 302, patient 304, physician 306, results count 308, earliest result 310, and latest result 312. Start-up window 300 further includes a select report choice 328 for either a single encounter 314 (to be described below; see FIG. 12) or an encounter comparison 316 (to be described below; see FIG. 13), a DISPLAY button 318, which leads to a separate window (not shown, see FIG. 12) to display color-based report 114 for data interpretation, a SETTINGS button 320, which leads to a separate window for establishing all user-defined control options (not shown, see FIG. 4), an EXIT button 322, which provides a means to exit the program, and an information button 324, which provides additional user information on how computer program 112 operates. All of the information provided, options provided, user interface techniques used, etc., depicted in start-up window 300 are shown as an example only. Other information may be displayed, other options may be available and the graphical user interface may be different without departing from the scope of the invention.

Still referring to FIG. 3, Patient ID column 302 includes rows of numeric data ranging from about 1 to X, where X is based on the storage capacity of the processing station 106. Typically X is less than 1000 in a single physician's office and more than 1000 in hospital or physicians' group settings. Once apprised of the current invention, one skilled in the art may recognize that start-up window 300 may also include information for only one patient, such as, for example, when a single patient utilizes computer program 112 outside a clinical setting. Such a use may help a patient in training themselves to maintain a certain treatment regimen. However, in an exemplary embodiment, the user may be medically trained personnel such as a physician, nurse or diabetes educator or other medical professional. Patient column 304 may include rows of alphabetic data listing all patients that have already had blood glucose results uploaded to computer program 112. Physician column 306 may include rows of alphabetic data listing the name of the physician attending to the corresponding patient. The results count column 308 may include rows of numeric data that correspond to the total number of results for each patient that were uploaded to computer program 112. The earliest result column 310 may include rows of numeric data representing the date of the earliest uploaded results from a patient's metering system for each patient in patient column 304. The latest result column 312 may include rows of numeric data representing the latest uploaded results from a patient's metering system for each patient in patient column 304.

Referring again to FIG. 3, to select a report 328, the user instructs computer program 112 to use either a single encounter 314 or an encounter comparison 316. For both report types, the user must identify the start date for the analysis from dropdown menus 330, 332, 334. The start date can optionally be, for example, the last upload date. To set all user-defined control options, the user clicks on SETTINGS button 320 which brings up a separate window displaying SETTING FOR COLOR MAPPING REPORT (see FIG. 4 which depicts an exemplary demonstration version of the SETTING FOR COLOR MAPPING REPORT). To view the color-based report 114 for data interpretation generated by computer program 112, the user clicks on DISPLAY button 318 which brings up a separate window displaying the patient-specific color-based report 114 for data interpretation (see FIG. 12 which depicts an exemplary Color Mapping Report). To exit computer program 112, the user clicks on EXIT button 322 and computer program 112 is closed. Various graphical user interface designs may be used without departing from the scope of the invention. Further, various ways in which a user may interact with the graphical user interface include, but are not limited to mouse and joystick controls, keyboard controls, voice recognition controls, touch screen controls, etc. without departure from the scope of the invention.

FIG. 4 illustrates an exemplary window for setting the parameters to generate a color-based report 114 for data interpretation, i.e., SETTING FOR COLOR MAPPING REPORT (shown here as Color Mapping Report Demonstration 400) in this exemplary embodiment. To view this window, user clicks on SETTINGS button 320 on start-up window 300 (see FIG. 3). Though listed in sequence, the selections which activate these functions may be selected at any time and be changed interactively. The user may select in any order the following user-defined control options for color coding numeric results from a patient's metering system during an encounter. To select day and time slots 402, the user chooses a number of days 404 ranging from about 0 to 84 by toggling the up or down arrows and the user chooses the number of time slots 410 ranging from about 0 to 24 (e.g., shown as 7, 10, or 24 in the present embodiment, however, other values may be implemented in accordance with other exemplary embodiments) by highlighting one of the circles preceding the number of choice. Number of time slots 410 correspond to the number of possible readings during a 24-hour period of blood glucose testing. Number of days 404 corresponds to the number of days that will be shown in the resultant color-coded report, with the number of days not necessarily limited to the 0 to 84 range provided above. To set limits and targets 418, the user must first choose a type 420 by highlighting a circle preceding Standard 426 or highlighting a circle preceding Normalized 428 (as will be defined below). In Standard 426 mode, to set a low limit 430, a low target 432, an upper target 434, and a high limit 436, all ranging from about 0 mg/dL to 400 mg/dL (or about 1 to 22 mmol/L), the user toggles the up or down arrows immediately under each choice. In Normalized 428 mode, to set a low percent limit 460, a target percent 462, and a high percent limit 464, the user toggles the up or down arrows immediately under each choice. Low percent limit 460, target percent 462 and high percent limit 464 can range from about 0 percent to ±500 percent and preferably range from about ±20 to ±200 percent. The embodiment in FIG. 4 shows one set of limits and targets. However, as is known to those skilled in the art, multiple limits and targets can be used. Multiple limits and targets may be used to differentiate between different time periods in the day, for example, the low and high targets for bedtime may be 100 and 140 respectively, the low and high targets for post-meal may be 80 and 180 respectively, and the low and high targets for pre-meal may be 80-120 respectively. Similarly, multiple limits and targets may be used to differentiate between different patient types for example gestational patients, Type 1 patients, Type 2 patients, etc.

To select colors 500, the user clicks on a dropdown menu 502 for a low color 504 and highlights one color from the list of red, green, blue, cyan, yellow, or magenta. The selected color is displayed in a box 506 next to dropdown menu 502. To set a high color 508, the user chooses from the color list in a dropdown menu 510 excluding the low color choice 504. The selected color is displayed in a box 512 next to dropdown menu 510. The user also selects a neutral color 514 for the target range defined by lower target 432 and upper target 434 or target percent 462 by clicking on one of the circles preceding white 520 or gray 521 color choice, respectively. Black (not shown) can also optionally be included as a color choice for neutral color 514. These colors are provided as examples whereas different color combinations can be used. Alternatively, a user may be able to choose from a number of color schemes where each color scheme includes multiple colors predefined to represent low, high, neutral, etc. Similarly, a single color scheme may be predefined for the system to provide uniformity if the system is being used by many users.

Still referring to FIG. 4, the user also selects how the cells and results 524 are processed when there are multiple results in a cell. The user selects a cell processing selection 526 from a dropdown menu 528. Cell processing selection 526 includes, but is not limited to, all results, the average of results, the results outside the target, the lowest results, the highest results, the earliest results, the limit to two earliest results, the limit to three earliest results, the latest result (s), the limit to two latest results, the limit to three latest results, etc. The user also has the options to disable color representation 530 or to include numeric values 532 in each cell by clicking on the respective box preceding the selection.

For both single encounters and encounter comparisons, the user may select report formatting 538 options by clicking on the respective boxes preceding the following selections: include statistics 546, include pie charts 548, and include cell information 550. The user can also select to change text size 552 by choosing from a dropdown menu 554 and for single encounter reports only, can indicate if the weekend days 556 should be highlighted by clicking on a box preceding the selection. To accept all of the appropriate control options, the user clicks an OK button 560 and to cancel without accepting any changes to control options the user clicks a CANCEL button 562. To obtain more information about any feature in this window, the user can click on an information button 564. It may be desirable to have other settings or to have less settings than shown in FIG. 4. Any combination of the settings shown and described may be found to be desirable.

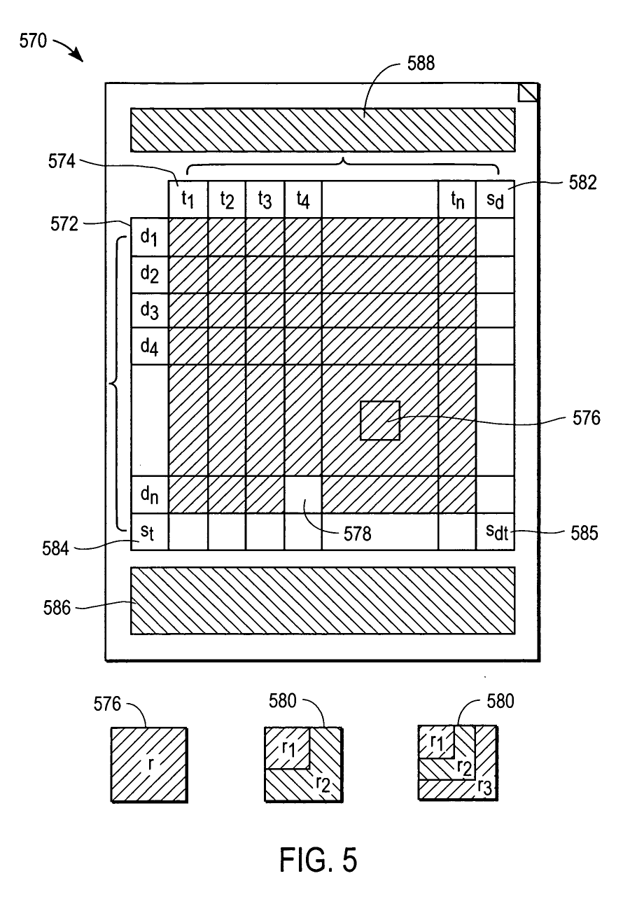

FIG. 5 is a template 570 for a color-based report 114 for data interpretation generated by computer program 112 according to an exemplary embodiment. Conventional blood glucose metering systems record a date and time stamp when a blood glucose level is measured and therefore can be entered into a table similar to template 570. Several modifications (to be described below) to template 570 can occur depending on the type of color-based report 114 generated by computer program 112. The types of color-based reports 114 that can be generated by computer program 112 include, but are not limited to, a single encounter color-based report (see FIG. 12), a normalized color-based report (not shown) and an encounter comparison color-based report (not shown).

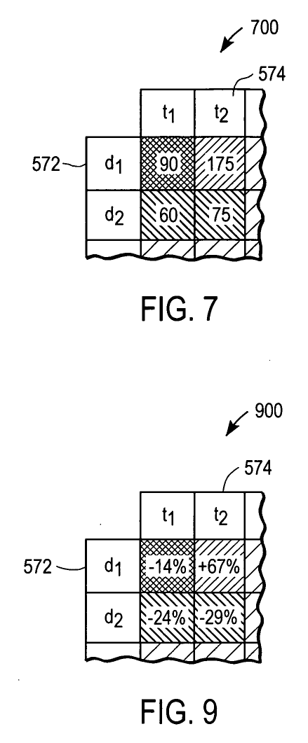

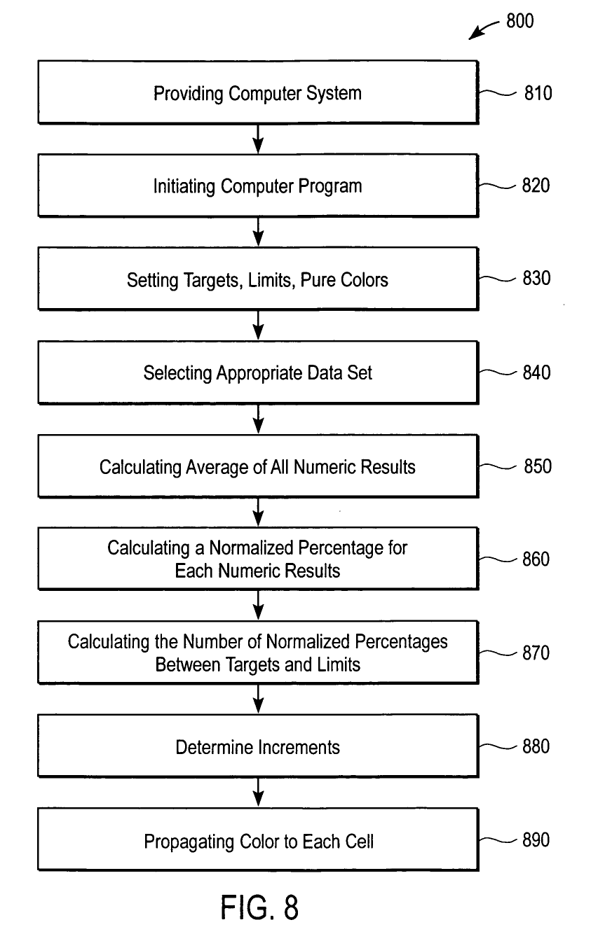

In template 570, each row indicates a day 572 and each column indicates a time period 574 throughout day 572. A plurality of time periods 574 can include before breakfast, after breakfast, before lunch, after lunch, before dinner, after dinner, and night. Other relevant time periods 574 can include before, during, or after exercise, and before or after taking medication, etc. Time periods 574 can range from about two to seven hours depending on user preferences. For example, after breakfast can be about two hours while night can be about seven hours. Thus, time periods 574 can be of unequal duration even though the time periods are typically shown as equal size on template 570. Therefore, each cell within template 570 represents a blood glucose numeric result 576 from time period 574 of day 572. If no measurement was taken for time period 574 of day 572, the cell 578 contains no data. If multiple measurements were taken during time period 574 of day 572, all of the results are indicated within the appropriate cell 580 with the appropriate color coding (to be described below) for each result. Multiple measurements within cell 580 can be represented by equally dividing cell 580 by width and height based on the number of results (as shown at bottom of FIG. 5), by equally dividing the area of cell 580 by the number of results (not shown), or by proportionally dividing cell 580 based on the time the result was measured (not shown). In addition, a statistics column 582 and a statistics row 584 can optionally be provided to give the number of readings taken per day 572 and the average reading on that day 572, the number of readings taken during time period 574 and the average reading during time period 574 and other statistics including standard deviation. An overall statistic 585 can also optionally be included in the lower right corner of report 570. Optionally, averages for each column and row can also be color coded (not shown). Pie charts (see e.g. FIG. 12) for time periods 574 can optionally be provided at the bottom of each column in an analysis region 586 to indicate the percentage of results within a defined glucose range. An overall pie chart (see e.g. FIG. 12) can optionally be displayed to indicate the percentage of readings that fall into the following categories: high, above target, within target, below target and low. An information region 588 at the top of template 570 provides patient information, such as, for example, current report date, and patient identification. An exemplary method for assigning color to cells is described below (see FIGS. 7 and 8).

FIG. 6 is an exemplary flowchart illustrating a sequence of steps in process 600 for color coding blood glucose numeric results by a computer program 112 according to an exemplary embodiment. Process 600 is described below utilizing FIG. 7.

Process 600 includes first providing a system 100 and method 200 as described above with respect to FIGS. 1 through 5, and as set forth in step 610 of process 600. The provided system 100 includes a hardware and software for inputting, processing, and reporting blood glucose numeric results, as previously described. During process 600, computer program 112 assigns the numeric results from a single encounter to appropriately labeled cells of a single encounter color-based report 700. The single encounter color-based report 700 includes multiple rows, each of which includes data from one day 572 of recording, and multiple columns, each of which includes data from a time period 574 throughout a day. Each cell is color coded depending on the numeric results within the cell. Cells with numeric results falling outside of the pre-set target range 432, 434 are propagated by the appropriate color as described below. Cells with numeric results within the pre-set target range 432, 434 are propagated with a neutral color, for example, white 520 or gray 521, as described below.

Next, the user initiates the computer program 112 as set forth in step 620. To initiate the computer program 112, the user must access a processing station 106 of a system 100 and open the computer program 112 using the appropriate input device 108 such as, for example, a mouse, a keyboard, a joystick or a stylet, etc.

The user then sets the target range (including a lower target 432 and an upper target 434), the low limit 430 and the high limit 436 as set forth in step 630. The target range 432, 434, low limit 430 and high limit 436 can range in an exemplary embodiment, from about 0 mg/dL to about 400 mg/dL, more usually from about 80 to 120 mg/dL for the target range 432, 434, about 60 mg/dL for the low limit 430 and 200 mg/dL for the high limit 436. In this step, the user also selects the low color choice 504 and the high color choice 508. Color choices include red, green, blue, cyan, yellow or magenta. The computer program 112 optionally may allow use of a single color, for example, blue for the low limit 430 and a different single color, for example, red for the high limit 436. The user also selects the neutral color, for example white 520 or gray 521. In accordance with an alternative embodiment, the targets, limits, and colors may come preset to a default setting. The default may be overridden to provide customized settings.

The user then may select the appropriate data set to be analyzed as set forth in step 640. The data set is retrieved by highlighting the appropriate patient 304 on start-up window 300 of computer program 112.

Next, the computer program 112 may determine the lower data number (NL) by counting the number of numeric results between the low limit 430 and the lower target 432 and determines the upper data number (NU) by counting the number of numeric results between the upper target 434 and high limit 436 as set forth in step 650.

The computer program 112 then may determine the increments of change in the color byte values, as set forth in step 660. For the numeric results between the low limit 430 and the lower target 432, the computer program 112 calculates the increment of change (IL) by 255/NL, if white is selected for the neutral color, or 128/NL, if gray is selected for the neutral color, where NL is lower data number established in step 650. For the numeric results between the upper target 434 and the high limit 436, the computer program 112 calculates the increment of change (IU) by 255/NU if white is selected for the neutral color, or 128/NU if gray is selected for the neutral color, where NU is the upper data number established in step 650.

Subsequently, the computer program 112 may propagate the appropriate color(s) to the appropriate cell as illustrated in FIG. 7 and as set forth in step 670. In an exemplary embodiment, color byte values (0-255) are used to represent R, G, B (red, green, blue) color components, for example, gray (128, 128, 128), white (255, 255, 255), red (255, 0, 0), green (0, 255, 0), blue (0, 0, 255), cyan (0, 255, 255), yellow (255, 255, 0), and magenta (255, 0, 255). One skilled in the art will recognize that other color representations are possible, for example, hue, saturation, and luminosity without departing from the scope of the invention. In this step, the computer program 112 assigns the low limit color 504 byte value to all numeric results at or below the pre-set low limit 430. For numeric results between the low limit 430 and the lower target 432, the computer program 112 sorts the numeric results in decreasing order and assigns a calculated increment of change (CIL) for the appropriate color byte component by the equation B±(IL*XL) where B is the byte value of the component color, IL is the increment of change, and XL increases by I for each sorted numeric result and ranges from 1 to NL such that more intense (e.g. increasing) shades of the low color 504 will be assigned to the appropriate numeric results as the numeric results approach the low limit 430 (i.e. as the numeric results decrease to the low limit 430). For numeric results within the pre-set target range 432, 434 established by assigning the lower target 432 and the upper target 434, the computer program 112 assigns the neutral color byte values, for example white 520 (255, 255, 255) or gray 521 (128, 128, 128). For numeric results between the pre-set upper target 434 and the high limit 436, the computer program 112 sorts the numeric results in increasing order and assigns the calculated increment of change (CIU) for the appropriate color byte component by B±(IU*XU) where B is the byte value of the component color, IU is the increment of change, and XU increases by 1 for each sorted numeric result and ranges from 1 to NU such that more intense (e.g. increasing) shades of the high color 508 are assigned to the appropriate numeric results as the numeric results approach the high limit 436 (i.e. as the numeric results increase to the high limit 436). The computer program 112 may assign high color 508 byte values to all numeric results at or above the pre-set high limit 436. Once all cells have been propagated with the appropriate color, the computer program 112 generates a single encounter color-based report (see FIG. 12), thus providing a rapid visualization means to inspect a large data set of blood glucose results.

FIG. 8 is a flowchart illustrating a sequence of steps in process 800 used to calculate a normalized percentage for each numeric result (i.e. to determine the variability within the numeric results) from a single encounter by a computer program 112 according to an exemplary embodiment. Process 800 is described below utilizing FIG. 9.

Process 800 includes first providing a system 100 and method 200 as described above with respect to FIGS. 1 through 5, and as set forth in step 810 of process 800. The provided system 100 includes a means for inputting, processing, and reporting blood glucose numeric results, as previously described. During process 800, computer program 112 calculates a results average for all the numeric results and then calculates the variability from the average for each numeric result. The computer program 112 then assigns the appropriate shade of color(s) to each cell based on the normalized percentage to generate a normalized color-based report 900 for a single encounter. The normalized color-based report 900 includes multiple rows, each of which includes normalized data from one day 572 of recording, and multiple columns, each of which includes normalized data from a time period 574 throughout the day 572. Each cell is color-coded depending on the normalized percentage (as will be described below). Cells with normalized percentages falling outside of the pre-set target percent 462 are propagated by the appropriate color as described below. Cells with normalized percentages within the pre-set target percent 462 are propagated with a neutral color, for example, white 520 or gray 521.

Next, the user initiates the computer program 112 as set forth in step 820. To initiate the computer program 112, the user must access a processing station 106 of a system 100 and open computer program 112 using the appropriate input device 108 such as, for example, a mouse, a keyboard, a joystick or a stylet, etc.

The user then sets the target percent 462, the low percent limit 460 and the high percent limit 464 as set forth in step 830. The target percent 462, low percent limit 460 and high percent limit 464 can range from about 0 percent to about ±500 percent, typically from about 0 percent to ±200 percent and more typically from about ±20 percent to ±200 percent. In this step, the user also selects the low color choice 504 and the high color choice 508. Color choices can include red, green, blue, cyan, yellow or magenta. The computer program 112 optionally may allow use of a single color, for example, blue for the low percent limit 460 and a different single color, for example, red for the high percent limit 464. The user also selects the neutral color, white 520 or gray 521.

The user then selects the appropriate data set as set forth in step 840. The data set is retrieved by highlighting the appropriate patient 304 on start-up window 300 of computer program 112.

Next, the computer program calculates the results average \overline{X} as set forth in step 850. To calculate the results average \overline{X} the computer program adds all numeric results from a single encounter and divides that value by the total number of numeric results. The results average \overline{X} will be used to generate a normalized percentage for each numeric result (see below).

The computer program then calculates a normalized percentage for each numeric result as set forth in step 860. The computer program calculates a normalized percentage by (NR/\overline{X}*100)−100, where NR is a numeric result and \overline{X} is the results average. One skilled in the art will recognize that calculations for normalized percentages using numeric results below the results average will generate negative normalized percentages. Thus, low percent limit 460 and target percent 462 low value are negative and high percent limit 464 and target percent 462 high value are positive. Further, one skilled in the art will also recognize that other methods for calculation normalized data may also be used without departing from the scope of the invention.

Next, the computer program calculates the number of normalized percentages between the targets and the limits as set forth in step 870. To calculate the low percent number (LP), the computer program 112 counts all of the normalized percentages between the low percent limit 460 and the target percent 462. To calculate the high percent number (HP), the computer program counts all of the normalized percentages between the target percent 462 and the high percent limit 464.

Next, the computer program determines the increments of change in the color byte values as set forth in step 880. For normalized percentages between the low percent limit 460 and the target percent 462, the computer program calculates the increment of change (IPL) by 255/LP if white 520 is selected as the neutral color, or 128/LP if gray 521 is selected for the neutral color, where LP is the low percent number established in step 870. For normalized percentages between the target percent 462 and the high percent limit 464, the computer program calculates the increment of change (IPU) by 255/HP if white 520 is selected as the neutral color, or 128/HP if gray 521 is selected as the neutral color, where HP is the high percent number established in step 870.

Subsequently, the computer program 112 propagates the appropriate color(s) to the appropriate cell as illustrated in FIG. 9 and as set forth in step 890. In one embodiment, color byte values (0-255) are used to represent R, G, B (red, green, blue) color components, for example, gray (128, 128, 128), white (255, 255, 255), red (255, 0, 0), green (0, 255, 0), blue (0, 0, 255), cyan (0, 255, 255), yellow (255, 255, 0), and magenta (255, 0, 255). In this step, the computer program 112 assigns the low color 504 byte value to all normalized percentages at or below the pre-set low percent limit 460. For normalized percentages between the low percent limit 460 and the target percent 462, the computer program 112 sorts the normalized percentages in decreasing order and assigns the calculated increment of change (CIPL) for the appropriate color byte component by B±(IPL*LP) where B is the byte value of the component color, IPL is the increment of change, and LP increases by 1 for each sorted normalized percentage and ranges from 1 to LP such that more intense (e.g. increasing) shades of the low color 504 will be assigned to the appropriate normalized percentages as the normalized percentages approach the low percent limit 460 (i.e. as the normalized percentages decrease to the low percent limit 460). For normalized percentages within the pre-set target percent 462, the computer program 112 assigns the neutral color byte values, for example white 520 (255, 255, 255), or gray 521 (128, 128, 128). For normalized percentages between the target percent 462 and the high percent limit 464, the computer program 112 sorts the normalized percentages in increasing order and assigns the calculated increment of change (CIPU) for the appropriate color byte component by B±(IPU*HP) where B is the byte value of the component color, IPU is the increment of change, and HP increases by 1 for each sorted normalized percentage and ranges from 1 to HP such that more intense (e.g. increasing) shades of the high color 508 are assigned to the appropriate normalized percentage as the normalized percentages approach the high percent limit 464 (i.e. as the normalized percentages increase to the high percent limit 464). The computer program 1 12 assigns high color 508 byte values to all normalized percentages at or above the pre-set high percent limit 464. Once all cells have been propagated with the appropriate color, the computer program 112 generates a normalized color-based report (not shown) to visualize the variability of the results. It should be noted that the above description for generating and propagating colors may be substituted with other methods without departing from the scope of the invention.

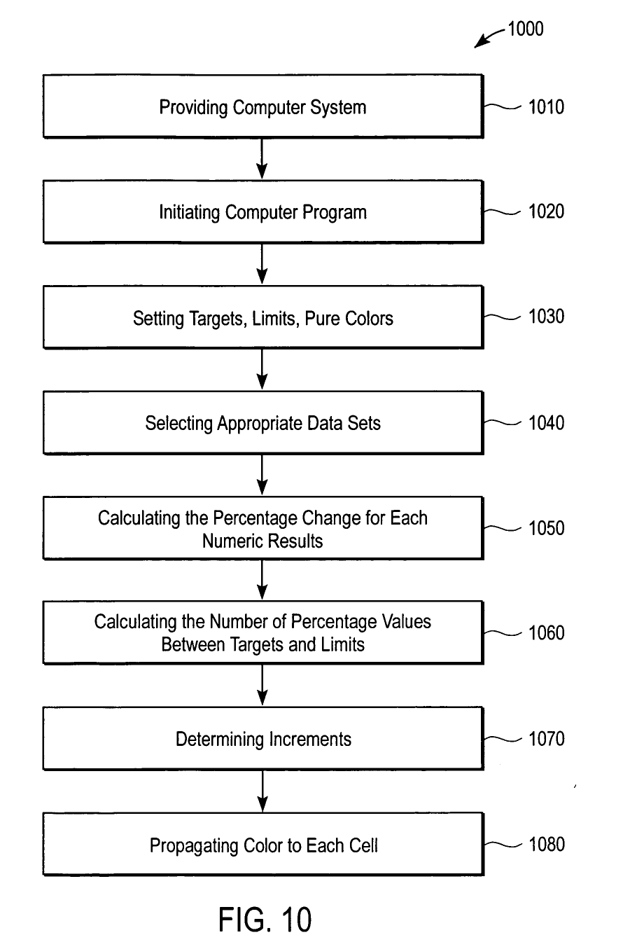

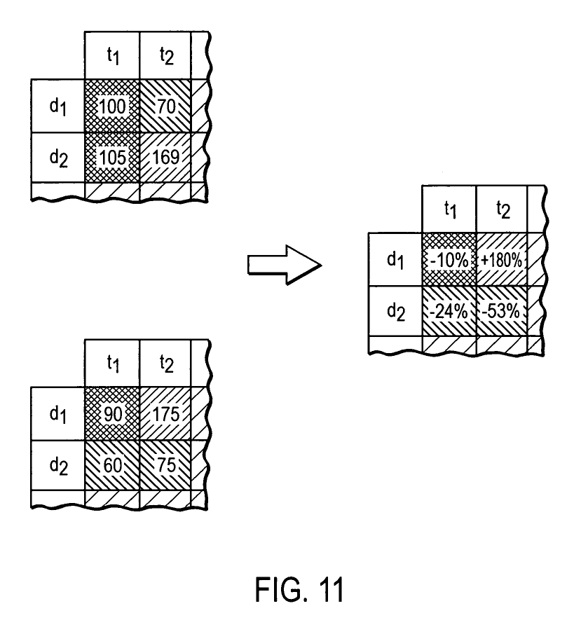

FIG. 10 is a flowchart illustrating a sequence of steps in process 1000 used to compare the numeric results from a previous encounter with the numeric results from a current encounter by a computer program 112 according to an exemplary embodiment. Process 1000 is described below utilizing FIG. 11.

Process 1000 includes first providing a system 100 and method 200 as described above with respect to FIGS. 1 through 5, and as set forth in step 1010 of process 1000. The provided system 100 includes a means for inputting, processing, and reporting blood glucose numeric results, as previously described. During process 1000, the user selects which data sets are to be compared and the computer program 112 then calculates the percent change between each numeric result from the previous encounter and the appropriate numeric result from the current encounter. The computer program 112 assigns the appropriate shade of color to each cell based on the calculated percent change between the numeric results of the previous and current encounters to generate an encounter comparison color-based data interpretation report. The encounter comparison color-based data interpretation report includes multiple rows, each of which includes comparison data for the two days of recording, and multiple columns, each of which includes comparison data for the two similar time periods during a day of recording. Each cell is color-coded depending on the calculated percent change (see below). Alternatively, other comparison methods and calculations may be used without departing from the scope of the invention.

Next, the user initiates the computer program 112 as set forth in step 1020. To initiate the computer program 112, the user must access a processing station 106 of a system 100 and open the computer program 112 using the appropriate input device 108 such as, for example, a mouse, a keyboard, a joystick or a stylet.

The user then sets the target percent 462, the low percent limit 460 and the high percent limit 464 as set forth in step 1030. The target percent 462, low percent limit 460 and high percent limit 464 can range from about 0 percent to about ±500 percent, typically from about ±20 percent to ±200 percent. In this step, the user also selects the low color choice 504 and the high color choice 508. Color choices include red, green, blue, cyan, yellow or magenta. The computer program 112 only allows use of a single color, for example, blue for the low percent limit 460 and a different single color, for example, red for the high percent limit 464. The user also selects the neutral color, white 520 or gray 521.

The user then selects the appropriate data sets as set forth in step 1040. The data sets are retrieved by highlighting the appropriate patient 304 on start-up window 300 of computer program 112 and selecting the appropriate dates from dropdown menus 432 and 434. In an exemplary embodiment, days of the week are matched between encounters such that a more meaningful comparison of the data can be made. For example, if the patient exercises on certain days of the week, the physician can compare like days of the week to ensure that the patient is managing his/her disease properly. For cells containing no results, the daily average, time-based average or the overall average can be used for comparison.

Next, the computer program 112 may calculate a percent change for each matched pair of numeric results as set forth in step 1050. The computer program calculates the percent change by (CNR/PNR*100)−100, where CNR is each current numeric result and PNR is each previous numeric result. One skilled in the art will recognize that calculations for percent change values using a current numeric result below a previous numeric result will generate negative percent change. Thus, low percent limit 460 and target percent 462 low value are negative and high percent limit 464 and target percent 462 high value are positive.

Next, the computer program 112 calculates the number of percent change values between the targets and the limits as set forth in step 1060. To calculate the low matched number (LM), the computer program counts all of the percent change values between the low percent limit 460 and the negative target percent 462. To calculate the high matched number (HM), the computer program counts all of the percent change values between the positive target percent 462 and the high percent limit 464.

Next, the computer program 112 determines the increments of change in the color byte values as set forth in step 1070. For percent change values between the low percent limit 460 and the target percent 462, the computer program 112 calculates the increment of change (IML) by 255/LM if white 520 is selected as the neutral color, or 128/LM if gray 521 is selected for the neutral color, where LM is the low percent number established in step 1060. For percent change values between the target percent 462 and the high percent limit 464, the computer program calculates the increment of change (IMU) by 255/HM if white 520 is selected as the neutral color, or 128/HM if gray 521 is selected as the neutral color, where HM is the high percent number established in step 1060.

Subsequently, the computer program 112 propagates the appropriate color(s) to the appropriate cell as illustrated in FIG. 11 and as set forth in step 1080. In one embodiment, color byte values (0-255) are used to represent R, G, B (red, green, blue) color components, for example, gray (128, 128, 128), white (255, 255, 255), red (255, 0, 0), green (0, 255, 0), blue (0, 0, 255), cyan (0, 255, 255), yellow (255, 255, 0), and magenta (255, 0, 255). In this step, the computer program 112 assigns the low color 504 byte value to all percent change values at or below the pre-set low percent limit 460. For percent change values between the low percent limit 460 and the target percent 462, the computer program 112 sorts the percent change values in decreasing order and assigns the calculated increment of change (CIML) for the appropriate color byte component by B±(IML*LM) where B is the byte value of the component color, IML is the increment of change, and LM increases by 1 for each sorted percent change values and ranges from 1 to LM such that more intense (e.g. increasing) shades of the low color 504 will be assigned to the appropriate percent change values as the percent change values approach the low percent limit 460 (i.e. as the percent change values decrease to the low percent limit 460). For percent change values within the pre-set target percent 462, the computer program 112 assigns the neutral color byte values, for example white 520 (255, 255, 255), or gray 521 (128, 128, 128). For percent change values between the target percent 462 and the high percent limit 464, the computer program 112 sorts the percent change values in increasing order and assigns the calculated increment of change (CIMU) for the appropriate color byte component by B±(IMU*HM) where B is the byte value of the component color, IMU is the increment of change, and HM increases by 1 for each sorted percent change value and ranges from 1 to HM such that more intense (e.g. increasing) shades of the high color 508 are assigned to the appropriate percent change values as the percent change values approach the high percent limit 464 (i.e. as the percent change values increase to the high percent limit 464). The computer program 112 assigns high color 508 byte values to all percent change values at or above the pre-set high percent limit 464. Once all cells have been propagated with the appropriate color, the computer program 112 generates an encounter comparison color-based report (not shown) to visualize change from the previous to the current encounter.

Once apprised of the current invention, one skilled in the art will recognize that at least one additional color-based data interpretation report can be generated using computer program 112. An encounter comparison normalized color-based report (not shown) for data interpretation can be generated by computer program 112 utilizing the numeric results from both a previous encounter and the current encounter to visualize change from the previous to the current encounter. To generate an encounter comparison normalized color-based data interpretation report, computer program 112 first calculates normalized percentages for all of the numeric results from both a previous encounter and the current encounter. Then computer program 112 calculates each percent change value using each current encounter normalized percentage compared to the appropriate previous encounter normalized percentage. Computer program 112 then propagates color to the each cell based on its relationship to the pre-set target percent 462, low percent limit 460, and high percent limit 464.

The invention is described in terms of its use with time series data such as blood glucose levels of a patient over time. It should be understood, however, that the color coding processes that are part of this invention are provided only for purposes of disclosing an exemplary embodiment of the invention and do not limit the scope of the claims of the present invention. In addition, such a color coding method and system can be used for tracking cholesterol levels, blood pressure readings, coagulation times and weight data. Further, in accordance with alternative embodiments, the chart may be coded using different visual methodologies, including but not limited to the use of patterns in cell blocks, the use of gray scale, different hatching densities, different dotting densities, etc.

### EXAMPLE

FIG. 12 provides sample numeric results data from a single encounter with a patient in the form of a single encounter color-based report. Numeric results (n=102) from a patient's metering system are uploaded to the system and recorded in the appropriate cells based on the time of day and the day of recording. Each cell is color coded based on how the numeric result compares to the pre-set target range (80 mg/dL to 120 mg/dL), pre-set low limit (40 mg/dL) and pre-set high limit (200 mg/dL). The color coding method is described in the current invention (see FIGS. 6 and 7). A data chart reader will quickly be able to assess, by looking briefly at the data chart, whether the patient is typically accomplishing their goals, or whether the patient's levels are typically above or below the target level and when the excursions are occurring (i.e. when goals are not being achieved).

Managing a chronic disease requires continued monitoring and controlling of health parameters, such as blood glucose levels for patients with diabetes, or cholesterol levels for patients with cardiovascular disease. Because of the chronic nature of such diseases, health parameters must be measured on a continuous basis by the patients themselves outside a clinical setting.

While the detailed drawings, specific examples, and particular formulations given described exemplary embodiments, they serve the purpose of illustration only. It should be understood that various alternatives to the embodiments of the invention described maybe employed in practicing the invention. It is intended that the following claims define the scope of the invention and that structures within the scope of these claims and their equivalents be covered thereby. The hardware and software configurations shown and described may differ depending on the chosen performance characteristics and physical characteristics of the computing and analysis devices. For example, the type of computing device, communications bus, or processor used may differ. The systems shown and described are not limited to the precise details and conditions disclosed. Method steps provided may not be limited to the order in which they are listed but may be ordered any way as to carry out the inventive process without departing from the scope of the invention. Furthermore, other substitutions, modifications, changes and omissions may be made in the design, operating conditions and arrangements of the exemplary embodiments without departing from the scope of the invention as expressed in the appended claims.

1. A computer-implemented method of visualizing time-dependent data comprising:
loading at least a first set of time-dependent data into a computer;
color coding the at least first set of time-dependent data with the computer; and
generating an output from the computer such that clinically significant excursions in the at least first set of time-dependent data are visually identified;
wherein the at least first set of time-dependent data is sorted according to a plurality of configurable time periods, and the color coding step includes selecting at least one of a color, a shade, a hue, a saturation, and a luminosity as a function of numerical values of the time-dependent data.

2. The method of claim 1, wherein the numerical values are one of measured values, normalized values, and comparison values.

3. The method of claim 1, wherein the color coding step includes setting a target and at least one action limit.

4. The method of claim 2, wherein the color coding step includes setting a target and at least one action limit.

5. The method of claim 3, wherein the target and at least one action limit are configurable by days of the week.

6. The method of claim 4, wherein the target and at least one action limit are configurable by days of the week.

7. The method of claim 1, wherein the color coding step includes assigning a neutral color to a time period containing no data.

8. The method of claim 2, wherein the color coding step includes assigning a neutral color to a time period containing no data.

9. The method of claim 7, wherein the neutral color is chosen from the group consisting of white and gray.

10. The method of claim 8, wherein the neutral color is chosen from the group consisting of white and gray.

11. The method of claim 1, wherein the plurality of configurable time periods includes one or more results.

12. The method of claim 2, wherein the plurality of configurable time periods includes one or more results.

13. The method of claim 1, wherein the time-dependent data is glucose concentration data, cholesterol concentration data, blood pressure data, blood coagulation result data, weight data or any combination thereof.

14. The method of claim 2, wherein the time-dependent data in glucose concentration data, cholesterol concentration data, blood pressure data, blood coagulation result data, weight data or any combination thereof.

15. A system for visualizing time-dependent data comprising:
a means for storing and processing data, wherein the means for processing data is configured to:
obtain at least a first set of time-dependent data from the means for storing data;
color code the at least first set of time-dependent data; and
generate an output from the computer such that clinically significant excursions in the at least first set of time-dependent data are visually identified;
wherein the at least first set of time-dependent data is sorted according to a plurality of configurable time periods, and the color coding step includes selecting at least one of a color, a shade, a hue, a saturation, and a luminosity as a function of a quantitative value.

16. A system for visualizing time-dependent data comprising:
a metering device;
data processing device;
a memory coupled to the data processing device;
a computer program running on the data processing device, the computer program configured to:
obtain at least a first set of time-dependent data from the means for storing data;
color code the at least first set of time-dependent data; and
generate an output from the computer such that clinically significant excursions in the at least first set of time-dependent data are visually identified;
wherein the at least first set of time-dependent data is sorted according to a plurality of configurable time periods, and the color coding step includes selecting at least one of a color, a shade, a hue, a saturation, and a luminosity as a function of a normalized value.

17. The system of claim 15, wherein the color coding step includes setting a target and at least one action limit.

18. The system of claim 16, wherein the color coding step includes setting a target and at least one action limit.

19. The system of claim 17, wherein the target and at least one action limit are configurable by days of the week.

20. The system of claim 18, wherein the target and at least one action limit are configurable by days of the week.

21. The system of claim 15, wherein the color coding step includes assigning a neutral color to a period of time containing no data.

22. The system of claim 16, wherein the color coding step includes assigning a neutral color to a period of time containing no data.

23. The system of claim 21, wherein the neutral color is chosen from the group consisting of white and gray.

24. The system of claim 22, wherein the neutral color is chosen from the group consisting of white and gray.

25. The system of claim 15, wherein the plurality of configurable time periods includes one or more results.

26. The system of claim 16, wherein the plurality of configurable time periods includes one or more results.

27. The system of claim 15, wherein the time-dependent data is glucose concentration data, cholesterol concentration data, blood pressure data, blood coagulation result data, weight data or any combination thereof.

28. The system of claim 16, wherein the time-dependent data in glucose concentration data, cholesterol concentration data, blood pressure data, blood coagulation result data, weight data or any combination thereof.

29. The system of claim 15, wherein the numerical values are at least one of measuring values, comparison values, and normalized values.

30. The system of claim 16, wherein the numerical values are at least one of measuring values, comparison values, and normalized values.

31. A computer-implemented method of visualizing time-dependent data comprising:
loading at least a first and second set of time-dependent data into the computer;
calculating a percent change between the first and second set of time-dependent data;
color coding the percent change between the first and second set of time-dependent data; and
generating an output from the computer such that clinically significant excursions in the percent change between the at least first and second set of time-dependent data are visually identified;
wherein the at least first and second set of time-dependent data is sorted according to a plurality of configurable time periods, and the color coding step includes selecting at least one of a color, a shade, a hue, a saturation, and a luminosity as a function of the percent change.

32. The method of claim 31, wherein the color coding step includes setting a target and at least one action limit.

33. The method of claim 32, wherein the target and at least one action limit are configurable by days of the week.

34. The method of claim 31, wherein the color coding step includes assigning a neutral color to a period of time containing no data.

35. The method of claim 34, wherein the neutral color is chosen from the group consisting of white and gray.

36. The method of claim 31, wherein the plurality of configurable time periods includes one or more results.

37. The method of claim 31, wherein the time-dependent data is glucose concentration data, cholesterol concentration data, blood pressure data, blood coagulation result data, weight data or any combination thereof.

38. A system for visualizing time-dependent data comprising:
a means for storing and processing data;
a means for obtaining at least a first and second set of time-dependent data from the means for storing data;
a means for calculating the percent change between the first and second set of time-dependent data;
a means for color coding the percent change between the first and second set of time-dependent data; and
a means for generating an output from the computer such that clinically significant excursions in the percent change between the at least first and second set of time-dependent data are visually identified,
wherein the at least first set of time-dependent data is sorted according to a plurality of configurable time periods, and the means for color coding selects at least one of a color, a shade, a hue, a saturation, and a luminosity as a function of the percent change.

39. The method of claim 38, wherein the means for color coding sets a target and at least one action limit.

40. The method of claim 39, wherein the target and at least one action limit are configurable by days of the week.

41. The method of claim 38, wherein the means for color coding assigns a neutral color to a period of time containing no data.

42. The method of claim 41, wherein the neutral color is chosen from the group consisting of white and gray.

43. The method of claim 38, wherein the plurality of configurable time periods includes one or more results.

44. The method of claim 38, wherein the time-dependent data is glucose concentration data, cholesterol concentration data, blood pressure data, blood coagulation result data, weight data or any combination thereof.

45. A system for visualizing time-dependent data comprising:
a metering device;
data processing device;
a memory coupled to the data processing device;
a computer program running on the data processing device, the computer program configured to:
obtain at least a first and second set of time-dependent data from the means for storing data;
calculate a percent change between the first and second set of time-dependent data;
color code the percent change between the first and second set of time-dependent data; and
generate an output from the computer such that clinically significant excursions in the percent change between the at least first and second set of time-dependent data are visually identified,
wherein the at least first and second set of time-dependent data is sorted according to a plurality of configurable time periods, and the color coding step includes selecting at least one of a color, a shade, a hue, a saturation, and a luminosity as a function of the percent change.
